(19) United States
(12) Patent Application Publication
(10) Pub. No.: US 2026/0205362 A1
(43) Pub. Date: Jul. 16, 2026

(54) NETWORK MAP ENRICHMENT

(71) Applicant: Cisco Technology, Inc., San Jose, CA (US)

(72) Inventors: Costas Filotheou Kleopa, Clarksville, MD (US); Akshay Rao Tate, Washington DC, DC (US)

(21) Appl. No.: 19/023,859

(22) Filed: Jan. 16, 2025

(51) Int. Cl. H04L 41/12; H04L 45/16

(52) U.S. Cl. CPC H04L 41/12; H04L 45/16

(57) ABSTRACT

Network administrators are looking for different ways to better identify and understand what devices are running on their network. Due to privacy and encryption, identifying the devices is becoming increasingly difficult, which can lead to security vulnerabilities and overutilization of resources. The described techniques provide a detection system that improves visibility to a network by utilizing data encoded according to various protocols. The detection system may enrich a network map for better asset and network resource allocation and provide personalized firewall rules based on hardware and operating systems running on the network.

### TECHNICAL FIELD

The present disclosure relates generally to the field of computer networking, and more particularly to enriching network maps for visibility, improved security, and reduced network resource usage using multicast domain name system (mDNS) and other protocols.

### BACKGROUND

Visibility within a network is important when managing a network. For instance, a network map may enable a network administrator to better understand what devices and/or versions of devices are running on the network. Different devices may utilize different types of hardware and operating systems, which may require use of different network resources.

Techniques to identify devices generally depend on using data included in non-encrypted traffic. However, with the prevalence of encryption techniques, traffic from devices in a network generally is encrypted, such that traffic signals in operating system versions have been modified by the providers to provide less information. For instance, device information may be encrypted, such that it is no longer visible to the network, resulting in less visibility. Further, reduced visibility can result in inaccurate network maps, causing increased network resource usage and/or security vulnerabilities to occur.

Accordingly, there is a need for a way to provide improved visibility and accuracy to network maps.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an environment in which a system can provide enriched network maps using a detection system, as described herein.

FIG. 2 illustrates a component diagram of an example detection system, according to the techniques described herein.

FIG. 3A illustrates a flow diagram of an example method of inspecting data packets according to the techniques described herein.

FIG. 3B illustrates a flow diagram of an example method of inspecting data packets according to the techniques described herein.

FIG. 4A illustrates an exemplary response that may be utilized by the detection system according to the techniques described herein.

FIG. 4B illustrates an example of data that may be included in an event, according to the techniques described herein.

FIG. 4C illustrates an example user interface that may be displayed according to the techniques described herein.

FIG. 5 illustrates a flow diagram of an example method for enriching network maps according to the techniques described herein.

FIG. 6 is a computer architecture diagram showing an illustrative computer hardware architecture for implementing a device that can be utilized to implement aspects of the various technologies presented herein.

### DESCRIPTION OF EXAMPLE EMBODIMENTS

### Overview

The present disclosure relates generally to the field of computer networking, and more particularly to enriching network maps for visibility, improved security, and reduced network resource usage using multicast domain name system (mDNS) and other protocols.

A method to perform the techniques described herein may include receiving, from a device in the network, network traffic comprising one or more data packets. The method may comprise identifying first data included in a first field of a packet of the one or more data packets. Further, the method may include, based on determining the first data matches a fingerprint of a plurality of fingerprints stored in a database of the network: generating an event comprising the first data and the fingerprint and identifying second data associated with one or more second fields of the packet. The method may also include, based on determining the second data matches one or more second fingerprints in the database, updating the event to include the second data and the one or more second fingerprints; and updating the network map to include the event.

Additionally, any techniques described herein, may be performed by a system and/or device having non-transitory computer-readable media storing computer-executable instructions that, when executed by one or more processors, performs the method(s) described above and/or one or more non-transitory computer-readable media storing computer-readable instructions that, when executed by one or more processors, cause the one or more processors to perform the method(s) described herein.

### Example Embodiments

Visibility within a network is important when managing a network. For instance, a network map may enable a network administrator to better understand what devices and/or versions of devices are running on the network. Different devices may utilize different types of hardware and operating systems, which may require use of different network resources. Thus, when a network map includes the types of devices running on the network, the system and/or network administrator can better manage security, resource usage, etc. of the network as a whole.

Techniques to identify devices generally depend on using data included in non-encrypted traffic. However, with the prevalence of encryption techniques, traffic from devices in a network generally is encrypted, such that traffic signals in operating system versions have been modified by the providers to provide less information. For instance, device information may be encrypted, such that it is no longer visible to the network, resulting in less visibility. Further, reduced visibility can result in inaccurate network maps, causing increased network resource usage and/or security vulnerabilities to occur.

Network administrators are looking for different ways to better identify their devices that runs over their network. In the past this was done mostly by analyzing protocols that included this info, but recently due to privacy and encryption these protocols became impossible to proceed with the same approach.

For instance, where operating systems running on the network are not known and/or accurate, network resources may be overutilized, causing network slowdowns, decreased available bandwidth, etc. As an example, a network administrator and/or system may deploy firewall policies may to network devices for implementation. Where a network map is inaccurate, the firewall policies may cover operating systems and/or hardware that are included in the network, as well as operating systems and/or hardware that is not running on the network. Thus, network devices may store and apply firewall policies that are not actually needed, causing more memory, bandwidth, etc. of the network to be used. Moreover, where particular operating systems and/or hardware is not known, security vulnerabilities associated with the operating systems and/or hardware can be introduced to the network, without the system and/or network administrator being aware or able to take proactive steps to protect against the vulnerability.

Accordingly, there is a need for a way to provide improved visibility and accuracy to network maps.

This disclosure describes techniques and mechanisms for a system to provide enriched network maps using a detection system and utilizing protocols. In some examples, the system may receive, from a device in the network, network traffic comprising one or more data packets. The system may identify first data included in a first field of a packet of the one or more data packets. The system may, based on determining the first data matches a fingerprint of a plurality of fingerprints stored in a database of the network: generate an event comprising the first data and the fingerprint; identify second data associated with one or more second fields of the packet; and based on determining the second data matches one or more second fingerprints in the database, update the event to include the second data and the one or more second fingerprints; and update the network map to include the event.

In some examples, the data packet(s) correspond to traffic sent using Multicast Domain Name System (mDNS) protocol. mDNS is a computer networking protocol that resolves hostnames to IP addresses within small networks that do not include a local name server. While the techniques described herein are described in relation to mDNS protocol, it is understood that any suitable protocol may be utilized. For instance, any protocol that provides traffic that is not fully encrypted may be used.

In some examples, the techniques of the system may be implemented by a detection system. For instance, the detection system may correspond to a service detector (e.g., such as a mDNS service detector or any other suitable monitoring and/or detection system). In some examples, the detection system may be integrated as part of a firewall service (e.g., such as Cisco Secure Firepower Service). In some examples, the detection system may be configured to receive and monitor network traffic.

In some examples, the system may comprise a pattern component. In some examples, the pattern component may include an intelligence engine. The intelligence engine may be configured to apply intelligence logic to the data packet(s) to determine which devices are coming into/onto the network and/or how the network can protect itself (e.g., if there are any specific vulnerabilities or intrusions that can occur based on the types of devices on the network). For instance, within a network, devices (e.g., network devices, internet of things (IoT) devices, etc.) may broadcast themselves to the local network through mDNS protocol. mDNS packets may comprise data consisting of questions and responses and there can be multiple questions or responses in each packet. These responses can contain information such a device name, manufacturer, model, and operating system, which may be encoded according to the mDNS protocol.

The pattern component may be configured to monitor the network traffic and identify packet(s) sent according to the mDNS protocol. Where the packet(s) are identified as non-mDNS packet(s), the system may ignore them. Where the packet(s) are identified as mDNS packets, the pattern component may utilize the intelligence engine to decode the packets.

The pattern component may parse the packet(s) to identify response(s) that comprise text responses (e.g., TXT type 16) that comprise device information (e.g., as the device's manufacturer and model, and occasionally firmware version and OS version). In some examples, each packet's data section contains a count of the number of responses as well as the responses themselves. Responses can have variable lengths so the pattern component may be configured to parse the responses in chronological order. Each response may be parsed to find the response type. If the response is a text response, the pattern component may determine that response will be further investigated, otherwise the response is skipped.

The pattern component may extract the device information in the form of raw text. The pattern component may be configured to access a database of the network to match the device information to specific patterns that the system has collected to see if a particular ID number of the hardware matches something stored in the database (e.g., if so, we have the full name of the hardware itself correlated/associated with the match). In some examples, the database may comprise fingerprints corresponding to patterns. In some examples, the database further stores associations between hardware identifiers, operating system versions, etc. and device information collected from databases of device manufacturers (e.g., such as Apple, Microsoft, etc.). Accordingly, the system may access the information from a database internal to the system and without making external calls to third-party databases and/or servers.

As an example, the pattern component may initially extract an identifier of the hardware associated with a device running on the network. The pattern component may determine whether the hardware identifier matches a field (e.g., such as a fingerprint) stored in the database. For instance, a name field in the packet may be read and an associated subprotocol may be matched with the fingerprint. As an example, a hardware identifier may comprise “model-MacBookPro18,3”. In this example, the pattern component may identify a match in the database, where the database returns the device name of “MacBookPro (14-inch 2021)”. Both the hardware identifier and the name of the device may be output to the event component to generate and log as part of an event.

Where a match is found and/or determined, the system may utilize the event component. In some examples, the pattern component may further read additional data included in additional fields. The data in each of the respective additional field may then be individually matched with that specific subprotocol's data fingerprints in the database. These patterns can be specific or general. A specific pattern would match both the key and value and return a separate (more informative value) whereas the general pattern would just match the key and use the value. As an example, a specific pattern may be “model=D53gAP”, which may be matched in the database and return a value of “iPhone 12”. In some examples, such as where the particular model is not stored in the database, the system may still identify a match between the model and a general pattern. For instance, the system may store an association between “model=” and return “D53gAP”. Accordingly, the system may provide an indication of the association to the update component for use in updating the database and/or pattern matching algorithms.

In some examples, the system may comprise an event component. In some examples, the event component is configured to generate event(s) associated with the data packets. For instance, an event may comprise device information (e.g., hardware type, operating system type, manufacturer, etc.). The event may be generated after an initial match between the hardware identifier and the fingerprint in the database is made. For instance, when the system identifies a match between a device type and name stored in the database, the event component may create separate events for each device to provide a cleaner integration. At the same time, if any of the devices provide device information including an operating system version in the data packets, the system can match the hardware and/or operating system version with a corresponding Common Product Enumerator (CPE) format. The event component may be configured to utilize the CPE format and include the device information and corresponding CPE format as an additional fingerprint for the network map.

The event may be updated to include device information and/or information associated with additional matches between the additional fields and the database. In some examples, the event component is configured to output the event to the map component, such that a network map can be updated in real-time.

In some examples, the event component is configured to generate discovery events associated with packet(s) that are identified as being part of the protocol, but do not have a match between the hardware identifier and a field in the database. The discovery event may store the device information and be utilized by the update component at a later time.

In some examples, the system may comprise a map component. In some examples, the map component is configured to receive event(s) from the event component and populate and/or update a network map displayed to a network administrator. In some examples, the map component is configured to update in real-time. In some examples, the map component may be configured to provide personalized firewall intrusion prevention rules to the network. For instance, by providing improved identification of operating systems, the system may provide recommended firewall rules based on what operating systems and hardware is running on the network. Thus, based on the operating system or hardware, the system may apply firewall rules that are specific to a particular type of operating system at a particular network device and/or set of network devices. Therefore, instead of deploying firewall rules that do not apply to a particular device, the system can prevent excessive firewall rules from being implemented within the network, thereby preventing slowdowns within the network due to overutilization of network resources.

In some examples, the system may comprise an update component. The update component may be configured to update and/or adjust the pattern matching algorithms utilized by the system. For instance, as new devices and operating systems are released, new hardware identifiers and operating system types are introduced to the network. The update component may be configured to report device information associated with the new devices and incorporate the new information into the network map. In some examples, the update component may be configured to update the algorithms in real-time and/or at regular time intervals. For instance, feedback from a user (e.g., such as a network administrator), web crawlers, updates from third-party databases, etc. may be used to update the algorithms.

In some examples, the update component is configured to update the network map in real-time. For instance, where packet(s) from a particular device have not been received for a period of time (e.g., such as 2 minutes, 3 minutes, etc.), the update component may determine that the packet(s) have expired and may remove the device from the network map. Accordingly, the network map may reflect real-time information about devices currently running on the network.

In some examples, the update component may be configured to handle discovery events. For instance, the update component may be configured to determine whether a hardware identifier matches a hardware type associated with a manufacturer. For instance, the update component may utilize web crawlers or input from a network administrator to make the determination. Where a match is determined, the associated manufacturer may be identified or entered by the network administrator and the update component may update the database and algorithms utilized by the system to provide improved identification in future packets.

In some examples, such as where the system comprises a mDNS service detector, the system may utilize a NetBIOS logging feature for snort3. The system may extend the detection and logging of hardware and NetBIOS information by inspecting the contents of mDNS packets utilizing the techniques described herein.

In this way, the system may provide an improved detection system that can perform deep packet inspection of response data included in data packets. The system may provide the ability to detect device(s) not previously detectable, which utilizing new fingerprints in the database. By utilizing a database that provides fingerprints identifying device specific patterns, the system may more accurately identify device(s) running on a network. Accordingly, the system may provide improved asset and resource management of hardware running over a network. Further, by integrating with firewall services, the system may enhance the detection capabilities of the firewall, thereby improving security of the network.

Moreover, the system may provide a network map that is more accurate. For instance, operating system identification of the network map may be improved with greater identification accuracy. With the combination of the fingerprints stored in the database and the rest of the derived fingerprints that come through the network maps algorithm, the system may provide more accurate results on the operating system of a platform. This improvement in operating system identification enables personalized Firewall Intrusion prevention rules to be identified and applied to the network on a per-network device basis. For instance, the improved operating system detection algorithm also provides a more personalized version of the Firewall's Intrusion prevention policies by enabling the system to provide recommended and/or automated protection based on what operating systems are actually running on the network. For instance, based on the network running a particular operating system, the system may identify and apply a subset of firewall rules associated with the particular operating system and may deploy the subset of firewall rules to network device(s) associated with where the operating system is running and/or accessing the network. In contrast, existing techniques may implement firewall rules for a plurality of operating systems and may deploy the rules to all network devices of the network, resulting in network resources to be overutilized, slowdowns, etc. Accordingly, the techniques may prevent excess firewall rules from being implemented, thereby freeing up network resources and preventing slowdowns in the network (e.g., due to lack of bandwidth, etc.).

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

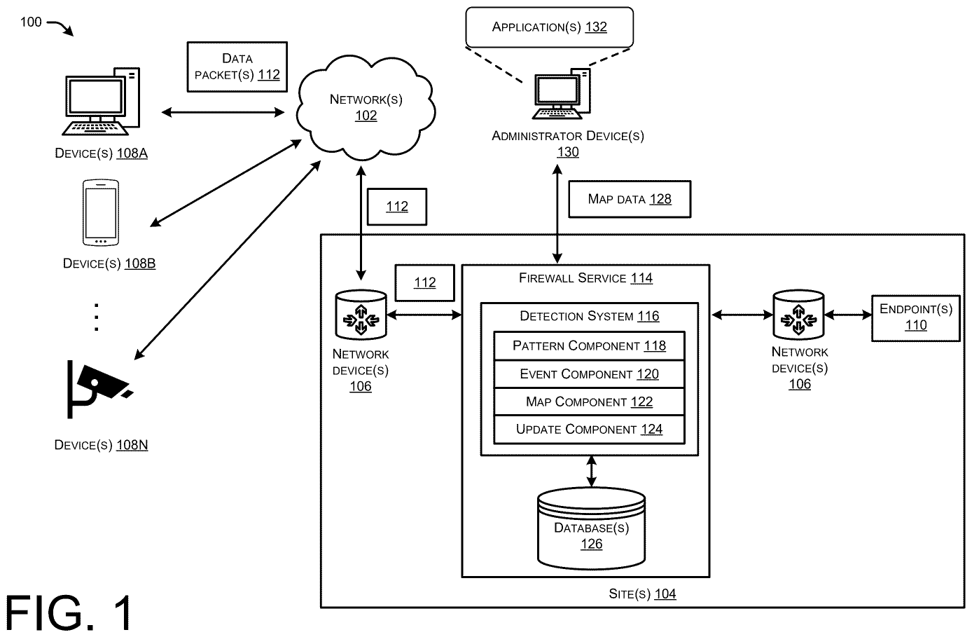

FIG. 1 illustrates a system-architecture diagram of an environment in which a system 100 can provide enriched network maps, improved network security, and more accurate visibility into a network. While the system 100 shows an example detection system 116 being implemented by a firewall service 114, it is understood that any of the components of the system 100 may be implemented on any device in the network 102. Further, while the system 100 is described in relation to mDNS protocol, it is understood that the techniques may applied to any suitable protocol or system in order to identify devices running on a network.

In some examples, the system 100 may include network(s) 102. The network(s) 102 may include one or more networks implemented by any viable communication technology, such as wired and/or wireless modalities and/or technologies. The network(s) 102 may include any combination of a service network, Personal Area Networks (PANs), SDCI, Local Area Networks (LANs), virtual LANs, Campus Area Networks (CANs), Metropolitan Area Networks (MANs), extranets, intranets, the Internet, short-range wireless communication networks (e.g., ZigBee, Bluetooth, etc.), RA VPNs, VPNs, ZTNA, Wide Area Networks (WANs)—both centralized and/or distributed—and/or any combination, permutation, and/or aggregation thereof. The network(s) 102 may include devices, virtual resources, or other nodes that relay packets from one network segment to another by nodes in the computer network. The network(s) 102 may include multiple devices that utilize the network layer (and/or session layer, transport layer, etc.) in the OSI model for packet forwarding, and/or other layers.

The system 100 may comprise a detection system 116. In some examples, the detection system 116 may be integrated as part of a firewall service 114 that is configured to provide personalized intrusion prevention rules and insights to network administrators via network maps. For instance, the firewall service 114 may correspond to Cisco Secure Firepower Service.

In some examples, the detection system 116 may correspond to a system that has complete visibility into the fabric of a given network (e.g., enterprise network, local network, etc.) and may be configured to monitor traffic flow within the network(s) 102. In some examples, the detection system 116 may comprise a controller, one or more processors, etc. In some examples, the detection system 116 may be integrated as part of Cisco Secure Firepower Service.

The detection system 116 may include a pattern component 118. In some examples, the pattern component may include an intelligence engine. The intelligence engine may be configured to apply intelligence logic to the data packet(s) to determine which devices are coming into/onto the network and/or how the network can protect itself (e.g., if there are any specific vulnerabilities or intrusions that can occur based on the types of devices on the network). For instance, within a network, devices (e.g., network devices, internet of things (IoT) devices, etc.) may broadcast themselves to the local network through mDNS protocol. mDNS packets may comprise data consisting of questions and responses and there can be multiple questions or responses in each packet. These responses can contain information such a device name, manufacturer, model, and operating system, which may be encoded according to the mDNS protocol.

The pattern component 118 may be configured to monitor the network traffic and identify packet(s) sent according to a particular protocol (e.g., such as the mDNS protocol). Where a portion of the data packet(s) 112 are identified as non-mDNS packet(s), the system may ignore them. Where a second portion of the data the packet(s) 112 are identified as mDNS packets, the pattern component 118 may decode the data included in the packets, such as by utilizing an intelligence engine and/or based on the particular protocol.

The pattern component 118 may parse the decoded data of the packet(s) to identify response(s) that comprise text responses (e.g., TXT type 16). The pattern component may search for the text responses, as the text responses may comprise device information (e.g., as the device's manufacturer and model, and occasionally firmware version and OS version). In some examples, each packet's “data” field may contain a count of the number of responses in the data packet, as well as the responses themselves. Responses can have variable lengths so the pattern component may be configured to parse the responses in chronological order. Each response may be parsed to find the response type. If the response is a text response, the pattern component may further inspect the response, otherwise the response is skipped. In some examples, each response may consist of one or more fields, including a “name” field, a “type” field, flags, and a “data” field. The “name” field may be of the format “<device name>. <subprotocol type>” and may be compressed. For example, the name field may comprise data including “User's MacBook Pro._airplay._tcp.local” or “Manufacturer Energy Strip 5600._hap._tcp.local”. The pattern component may be configured to utilize the data in the name field to match the subprotocol type to a fingerprint in the database 126 and/or to extract data (e.g., such as data associated with a network basic input/output system (NetBIOS)). The “data” field may comprise the format “<length><text>” repeating where each text section is of the form “<key>=<value>”. In some examples, the pattern component may identify the “data” field and extract the data comprising device information from the data field of the data packet. In some examples, the keys may not come in a specified order and/or may not always appear.

The pattern component 118 may be configured to extract the device information in the form of raw text. The pattern component 118 may be configured to access database(s) 126 (e.g., one or more physical and/or or virtual database(s)) of the network to match the subprotocol type, hardware identifier, device information, etc. to specific patterns that the detection system has collected to see if a particular identifier of the hardware matches something stored in the database(s) 126 (e.g., if so, we have the full name of the hardware itself correlated/associated with the match). In some examples, the database(s) 126 may store fingerprints corresponding to patterns. In some examples, the database(s) may further store associations between hardware identifiers, operating system versions, etc. and device information collected from databases of device manufacturers (e.g., such as Apple, Microsoft, etc.) and/or observed by the network and/or system over time. Accordingly, the system may access the information from database(s) 126 internal to the system and without making external calls to third-party databases and/or servers.

As an example, the pattern component 118 may initially extract an identifier of the hardware (e.g., the subprotocol type) associated with a device running on the network. The pattern component 118 may determine whether the hardware identifier matches a fingerprint stored in the database. For instance, the data in the “name” field in the packet may be read and the subprotocol type (e.g., such as a hardware identifier) may be matched with the fingerprint. As an example, a hardware identifier may comprise “model-MacBookPro18,3”. In this example, the pattern component may identify a match in the database, where the database returns the device type of “MacBookPro (14-inch 2021)”. Both the hardware identifier and the type of the device may be output to the event component to generate and log as part of an event.

In some examples, the pattern component may further read additional data from additional fields of the data packet(s) 112. For instance, the additional data may be read from the “data” field(s) and may be individually matched with respective mDNS data fingerprints (e.g., patterns) of the specific subprotocol indicated by the “name” field. The patterns may be specific and/or general. As an example, a specific pattern may match both the “key” and “value” with fingerprint(s) in the database, where the database returns a separate, more informative value that is included as part of the event. A general pattern may just match the “key” to a fingerprint and may use the “value” as device information included in the event. For example, a specific pattern may be where the system searches the database for a match to “model=D53gAP”, where the “key” comprises “model=” and the “value” comprises “D53gAP”. In this example, the system may match a fingerprint in the database, which may return the data comprising “iPhone 12”, indicating the type of device. In another example, such as where the particular model is not stored in the database, the system may utilize a general pattern, where the “key” value (e.g., “model=”) is entered and/or searched and the “value” (e.g., “D53gAP”) is returned and stored as part of an event and/or used for future fingerprint updates and/or associations with the device.

Accordingly, the system may provide an indication of the association to the update component for use in updating the database and/or pattern matching algorithms.

The detection system 116 may include an event component 120. In some examples, the event component 120 is configured to generate event(s) associated with the data packets. For instance, an event may comprise device information (e.g., hardware type, operating system type, manufacturer, etc.). The event may be generated after an initial match between the hardware identifier and the fingerprint in the database is made. For instance, the event component may create separate events for each device that matches with a respective fingerprint to provide a cleaner integration. At the same time, if any of the devices provide device information including an operating system version in the data packets, the system can match the hardware and/or operating system version with a corresponding Common Product Enumerator (CPE) format. The event component 120 may be configured to utilize the CPE format and include the device information and corresponding CPE format as an additional fingerprint for the network map.

The event may be updated to include device information and/or information associated with additional matches between the additional fields and the database. In some examples, the event component 120 is configured to output the event to the map component 122, such that a network map can be updated in real-time.

In some examples, the event component 120 is configured to generate discovery events where packet(s) from a device are identified as being part of the protocol, but the hardware identifier included in the data of the packet(s) do not match a fingerprint in the database. The discovery event may comprise the hardware identifier and/or other data from the data packet(s) and be utilized by the update component at a later time.

The detection system 116 may include a map component 122. In some examples, the map component 122 is configured to receive event(s) from the event component and populate and/or update a network map displayed to a network administrator. For instance, the map component 122 may provide the event(s) to the network administrator as part of map data 128. In some examples, map data 128 may comprise instructions to add or remove a user device, device(s) 108, and/or other device(s) from the network map. In some examples, the map component 122 is configured to update in real-time. In some examples, the map component may be configured to provide personalized firewall intrusion prevention rules to the network. For instance, by providing improved identification of operating systems, the system may provide recommended firewall rules based on what operating systems and hardware is running on the network. Thus, based on the operating system or hardware, the system may apply firewall rules that are specific to a particular type of operating system at a particular network device and/or set of network devices. Therefore, instead of deploying firewall rules that do not apply to a particular device, the detection system 116 can prevent excessive firewall rules from being implemented within the network, thereby preventing slowdowns within the network due to overutilization of network resources.

The detection system 116 may include an update component 124. The update component 124 may be configured to update and/or adjust the pattern matching algorithms utilized by the detection system 116 to identify device(s) running on the network(s) 102. For instance, as new devices and operating systems are released, new hardware identifiers and operating system types are introduced to the network. The update component may be configured to report device information associated with the new devices and incorporate the new information into the network map. In some examples, the update component may be configured to update the algorithms in real-time and/or at regular time intervals. For instance, feedback from a user (e.g., such as a network administrator), web crawlers, updates from third-party databases, etc. may be used to update the algorithms.

In some examples, the update component 124 is configured to update the network map in real-time (e.g., such as by sending map data 128). For instance, where packet(s) from a particular device have not been received for a period of time (e.g., such as 2 minutes, 3 minutes, etc.), the update component 124 may determine that the packet(s) have expired and may send map data 128 comprising instructions to remove the device from the network map. Accordingly, the network map may reflect real-time information about devices currently running on the network.

In some examples, the update component 124 may be configured to handle discovery events. For instance, the update component 124 may be configured to determine whether a hardware identifier matches a hardware type associated with a manufacturer. For instance, the update component 124 may utilize web crawlers and/or input from a network administrator to make the determination. Where a match is determined, the associated manufacturer may be identified or entered by the network administrator and the update component may update the database and algorithms utilized by the system to provide improved identification in future packets.

In some examples, such as where the detection system 116 comprises a mDNS service detector, the system may utilize a NetBIOS logging feature for snort3. The detection system 116 may extend the detection and logging of hardware and NetBIOS information by inspecting the contents of mDNS packets utilizing the techniques described herein.

In some examples, device(s) 108A, 108B, 108N (collectively referred to as device(s) 108 herein) may utilize one or more resources of site(s) 104 via one or more networks 102, such as, for example, the cloud network(s), by way of one or more process(es), such as, for example, DNS client(s), VPN client(s), browser(s), application(s), and/or software agent(s) executing on the device(s) 108.

In some examples, device(s) 108 (e.g., IoT device(s) or other user device(s), such as computer(s), cell phones, cameras, iHomes, digital assistants, thermometers, doorbell or security cameras, etc.) may be configured to communicate with other device(s) 108 operating on a local network (e.g., network(s) 102) provided by site(s) 104. For instance, device(s) 108 may be configured to broadcast data packet(s) 112 to other device(s) in the local network in order to communicate with the other device(s) via the network(s) 102.

The detection system 116 may be configured to communicate with one or more network device(s) 106. For instance, as noted above the detection system 116 may receive network data and/or session data (e.g., network traffic load data, network client data, etc.) or other data (e.g., application load data, data and/or metadata associated with WLCs, APs, etc.) from the network device(s) 106 that is associated with one or more session(s) of a user of the device(s) 108. The network device(s) 106 may comprise routers, switches, access points, stations, radios, or any other network device. In some examples, the network device(s) 106 may monitor traffic flow(s) within the network and may report information associated with the traffic flow(s) to the detection system 116.

In some examples, the system comprises site(s) 104. In some examples, the site(s) 104 comprise one or more server(s), enterprise network(s) and/or service(s) associated with a service provider, one or more network device(s) 106, etc. In some examples, the site(s) 104 correspond to one or more data center(s) comprising various network components, such as, for example, network switch(es) (also referred to as node(s)) operating on physical servers. In some examples, the site(s) 104 may comprise physical server(s) that may host one or more virtual machines. Each virtual machine may be configured to execute one of various operations and act as one or more virtual components for the cloud network(s) and/or enterprise/application network, such as, for example, application(s). In some examples, the physical server(s) may host any number of virtual machines. In some examples, the physical server(s) in the enterprise/application network may host the various network components of the enterprise/application network. In some examples, the device(s) 108 comprise one or more user(s), mobile device(s), and/or Internet of Things (IoT) device(s) located at one or more locations.

In some examples, device(s) 108 may be configured to send data packet(s) 112 that are encoded according to a particular protocol (e.g., such as mDNS and/or any other IoT based communications methods (e.g., such as AirPlay command message, a unique mDNS record that includes the device information, etc.)). In some examples, the data packet(s) 112 may comprise device data associated with a device, including a device name, hardware identifier, operating system version, device manufacturer, subprotocol type, and more.

The data packet(s) 112 corresponding to the traffic flow may be sent from device(s) 108 to the network device(s) 106 via network(s) 102. The network device(s) 106 may pass the data packet(s) through the firewall service 114 and/or detection system 116 before the data packet(s) reach endpoint(s) 110. Endpoint(s) 110 may correspond to any service, cloud, application, website, server, device, etc. and may be included as part of the site(s) 104 and/or may be external to the site(s) 104. In some examples, the data packet(s) 112 may correspond to device(s) 108 communicating via the network(s) 102 for discovery and/or to communicate with other IoT device(s) on the network(s) 102.

In some examples, the network device(s) 106 may communicate information. For instance, the network device(s) 106 may send data packet(s) 112 associated with data flows and/or session(s) to other network device(s). In some examples, the data packet(s) 112 and/or metadata associated with the data packet(s) 112 may be sent to and/or monitored by the detection system 116.

In some examples, the database(s) 126 further store firewall intrusion prevention policies that may be identified by the detection system 116 and recommended or implemented by a network administrator associated with administrator device(s) 130. For instance, the detection system 116 may provide recommended intrusion prevention rules to apply to the network(s) 102 to the administrator device(s) 130. The detection system 116 may also be configured to output a network map for display to application 132 on administrator device(s) 130. In some examples, the application 132 may correspond to an application provided by a service provider (e.g., such as Cisco) that enables an administrator of the network 102 to access the detection system 116 and/or firewall service 114. For instance, the application 132 may correspond to Cisco's Secure Firewall service.

In some examples, administrator device(s) 130 may send instructions to one or more network device(s) 106 via the detection system 116. In some examples, the instructions may comprise instructions to block or allow access, instructions to configure a policy for the network, and/or instructions to re-configure or update a policy for the network. In some examples, the instructions may include policies associated with a single link in the network (e.g., firewall policy, IP address, etc.). In some examples, the detection system 116 may be configured to be turned on/off based on the feedback or type of coverage the network administrator needs. For instance, the feature may be turned off in response to receiving instructions from the administrator device 130.

In this way, the system may provide an improved detection system that can perform deep packet inspection of response data included in data packets. The system may provide the ability to detect device(s) not previously detectable, which utilizing new fingerprints in the database. By utilizing a database that provides fingerprints identifying device specific patterns, the system may more accurately identify device(s) running on a network. Accordingly, the system may provide improved asset and resource management of hardware running over a network. Moreover, the system may provide a network map that is more accurate. For instance, operating system identification of the network map may be improved with greater identification accuracy. With the combination of the fingerprints stored in the database and the rest of the derived fingerprints that come through the network maps algorithm, the system may provide more accurate results on the operating system of a platform. This improvement in operating system identification enables personalized Firewall Intrusion prevention rules to be identified and applied to the network on a per-network device basis. For instance, the improved operating system detection algorithm also provides a more personalized version of the Firewall's Intrusion prevention policies by enabling the system to provide recommended and/or automated protection based on what operating systems are actually running on the network. For instance, based on the network running a particular operating system, the system may identify and apply a subset of firewall rules associated with the particular operating system and may deploy the subset of firewall rules to network device(s) associated with where the operating system is running and/or accessing the network. In contrast, existing techniques may implement firewall rules for a plurality of operating systems and may deploy the rules to all network devices of the network, resulting in network resources to be overutilized, slowdowns, etc. Accordingly, the techniques may prevent excess firewall rules from being implemented, thereby freeing up network resources and preventing slowdowns in the network (e.g., due to lack of bandwidth, etc.).

That is, unlike existing detection systems (e.g., such as mDNS service detector) which are simply configured to parse a host name from the data packets, the system described herein may provide an improved detection system that closes the gap in the existing detector by providing increased visibility of the local network devices through the mDNS protocol. That is, the detection system may provide deep packet inspection of mDNS response data and provide the ability to detect device(s) on a network that previously were not detectable (e.g., such as Printers, HomeKit devices, AirPlay devices, Macs, and iPads). Accordingly, the system may improve identification of device(s) over the network and provide more accurate visibility into the network.

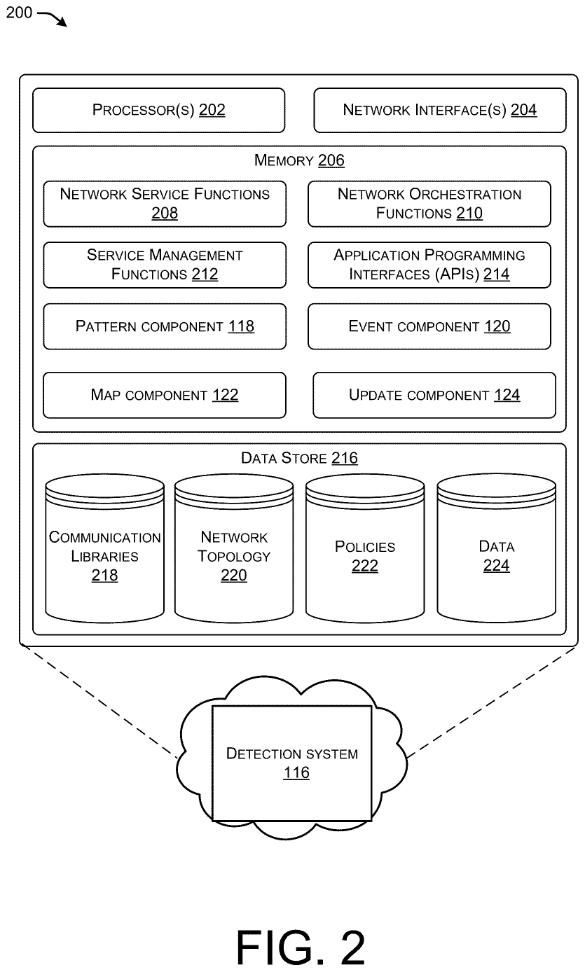

FIG. 2 illustrates a component diagram 200 of an example detection system, as described herein. In some instances, the detection system 116 may run on one or more computing devices in, or associated with, the network 102 (e.g., a single device or a system of devices). In some instances, the detection system 116 may be integrated as part of a firewall service 114 (e.g., such as Cisco's Secure Firewall service).

Generally, the detection system 116 may include a programmable controller that manages some or all of the controller activities of the network 102, and manages or monitors the network state using one or more centralized control models.

As illustrated, the detection system 116 may include, or run on, one or more hardware processors 202 (processors), one or more devices, configured to execute one or more stored instructions. The processor(s) 202 may comprise one or more cores. Further, the detection system 116 may include or be associated with (e.g., communicatively coupled to) one or more network interfaces 204 configured to provide communications with network device(s) 106, the edge device(s) 106 and other devices, and/or other systems or devices in the network 102 and/or remote from the network 102. The network interfaces 204 may include devices configured to couple to personal area networks (PANs), wired and wireless local area networks (LANs), wired and wireless wide area networks (WANs), SDCI's, and so forth. For example, the network interfaces 204 may include devices compatible with any networking protocol.

The detection system 116 may also include memory 206, such as computer-readable media, that stores various executable components (e.g., software-based components, firmware-based components, etc.). The memory 206 may generally store components to implement functionality described herein as being performed by the detection system 116. The memory 206 may store one or more network service functions 208, such as a slicing manager, a topology manager to manage a topology of the network 102, a host tracker to track what network components are hosting which programs or software, a switch manager to manage switches of the network 102, a process manager, and/or any other type of function performed by the detection system 116.

The detection system 116 may further include network orchestration functions 210 stored in memory 206 that perform various network functions, such as resource management, creating and managing network overlays, programmable APIs, provisioning or deploying applications, software, or code to hosts, and/or perform any other orchestration functions. Further, the memory 206 may store one or more service management functions 212 configured to manage the specific services of the network 102 (configurable), and one or more APIs 214 for communicating with devices in the network 102 and causing various controller functions to occur.

In some examples, the detection system 116 may include a pattern component 118. As described above the pattern component 118 may be configured to monitor traffic, decode data included in particular data packet(s), parse and extract device data, and determine matches between the decoded data and fingerprints stored in database(s) 126.

The detection system 116 may include an event component 120. As described herein, the event component 120 may be configured to generate event(s) corresponding to match(es) between data in a data packet and fingerprint(s) in database(s) 126. The event component 120 may also be configured to generate discovery event(s) for data packet(s) that include information not found in database(s) 126, which may be utilized by the update component 124.

The detection system 116 may include a map component 122. As described herein, the map component 122 may be configured to receive event(s) from the event component and populate and/or update a network map displayed to a network administrator. In some examples, the map component is configured to update the network map in real-time. In some examples, the map component may be configured to provide personalized firewall intrusion prevention rules to the network administrator.

The detection system 116 may include an update component 124. As described herein, the update component may be configured to update algorithms and/or the database(s) 126 utilized by the detection system 116. In some examples, the update component is configured to update the network map in real-time.

In some examples, one or more of the pattern component 118, event component 120, map component 122, and/or update component 124 may be configured to utilize artificial intelligence, machine learning, and/or generative AI to perform functionalities described herein. For instance, the pattern component 118 may be configured to utilize the model(s) to decode data packet(s) and/or identify matches between the data included in the name and data field(s) of the data packet(s) and fingerprint(s) in the database(s) 126.

In some examples, the artificial intelligence models are pre-trained using machine learning techniques. In some examples, the detection system 116 and/or firewall service 114 may store machine-trained data models for use during operation. Machine learning techniques include, but are not limited to supervised learning algorithms (e.g., artificial neural networks, Bayesian statistics, support vector machines, decision trees, classifiers, k-nearest neighbor, etc.), regression models, unsupervised learning algorithms (e.g., artificial neural networks, association rule learning, hierarchical clustering, cluster analysis, etc.), semi-supervised learning algorithms, deep learning algorithms, etc.), statistical models, etc. As used herein, the terms “machine learning,” “machine-trained,” and their equivalents, may refer to a computing model that can be optimized to accurately recreate certain outputs based on certain inputs.

Machine learning techniques include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. As used herein, the terms “machine learning,” “machine-trained,” and their equivalents, may refer to a computing model that can be optimized to accurately recreate certain outputs based on certain inputs. In some examples, the machine learning models include deep learning models, such as convolutional neural networks (CNN), deep learning neural networks (DNN), and/or artificial intelligence models. The term “neural network,” and its equivalents, may refer to a model with multiple hidden layers, wherein the model receives an input (e.g., a vector) and transforms the input by performing operations via the hidden layers. An individual hidden layer may include multiple “neurons,” each of which may be disconnected from other neurons in the layer. An individual neuron within a particular layer may be connected to multiple (e.g., all) of the neurons in the previous layer. A neural network may further include at least one fully-connected layer that receives a feature map output by the hidden layers and transforms the feature map into the output of the neural network. In some examples, the neural network comprises a graph where each node of the graph represents a layer within the neural network. Each node may be connected as part of a chain (e.g., a concatenation of layers). In some examples, input may be received by a node within the graph, the input is computed by the node and gets passed to one or more additional nodes in the chain.

In some examples, the models may be updated and/or re-trained in real-time. For instance, the update component 124 may update the one or more machine learning models based on discovery events, feedback from manufacturers, outputs from the machine learning models, input from a network administrator, etc.

The detection system 116 may further include a data store 216, such as long-term storage, that stores communication libraries 218 for the different communication protocols that the detection system 116 is configured to use or perform. Additionally, the data store 216 may include network topology data 220, such as a model representing the layout of the network components in the network 102 and/or data indicating available bandwidth, available CPU, delay between nodes, computing capacity, processor architecture, processor type(s), etc. The data store 216 may store policies 222 that include security data associated with the network, security policies configured for the network, firewall policies, intrusion prevention policies, firewall configuration data, network configuration policies, network configuration data, security posture data, and/or compliance policies configured for the network. The data store 216 may store data 224 including metadata, identifiers, device data, connection data, NetBIOS data, device information, fingerprint(s), hardware data, patterns, network data, keys, protocol data, event data, discovery event data, pattern matching algorithms, or any other data and/or information described herein.

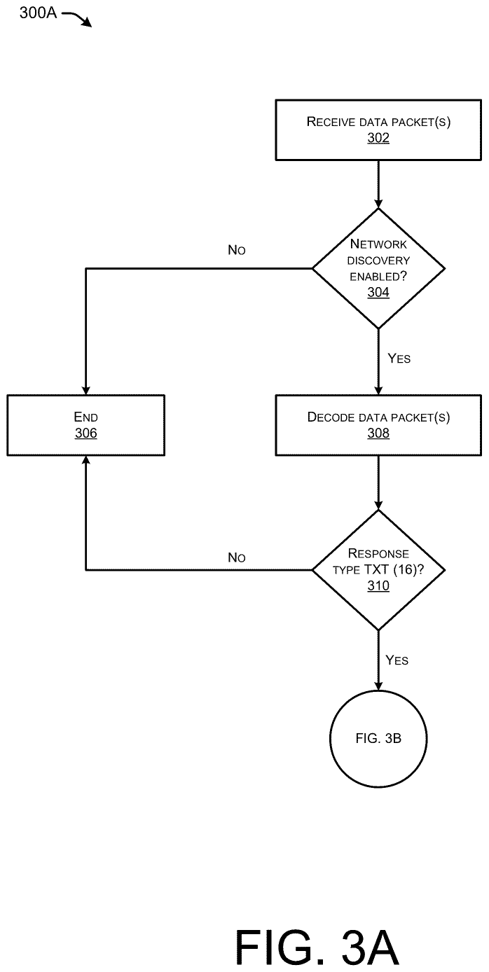

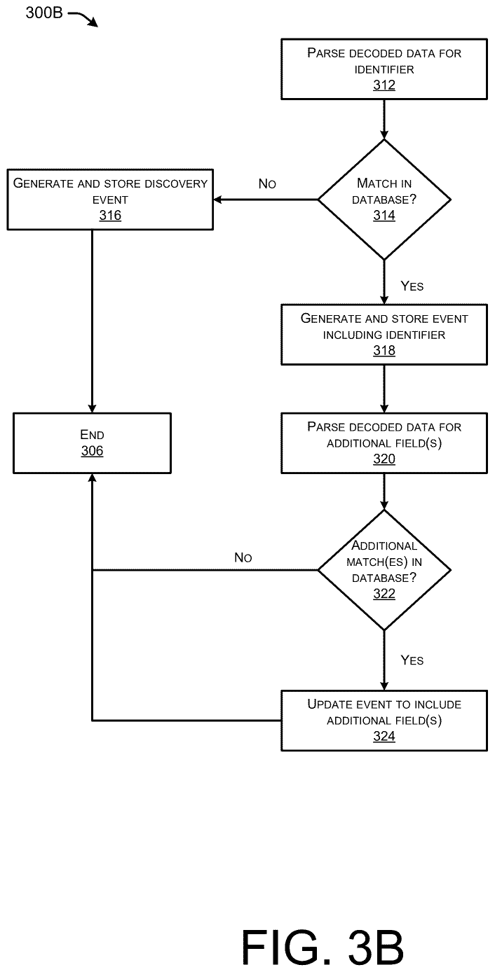

FIG. 3A illustrates a flow diagram of an example system 300A for inspecting data packets in order to enrich network maps and optimize network resource usage throughout a network, according to the techniques described herein. In some instances, the steps of system 300A may be performed by one or more devices (e.g., detection system 116, network device(s) 106, etc.) that include one or more processors and one or more non-transitory computer-readable media storing computer-executable instructions that, when executed by the one or more processors, cause the one or more processors to perform operations of system 300A. In some examples, the system 300A is performed when a data packet is received by the detection system. For instance, the system 300A may be performed for each data packet that is received. In some examples, the system 300A may be performed using one or more of the components of the detection system. In some examples, one or more steps of FIGS. 3A and/or 3B may be performed by an mDNS service detector. However, it is understood that the steps of FIGS. 3A and/or 3B are not limited to performance by the mDNS service detector.

At 302, the system 300A may receive data packet(s). For instance, the system 300A may receive data packet(s) 112 from device(s) 108. In some examples, the system 300A may determine whether to further inspect the data packet(s) based on whether the data packet comprises a mDNS packet. Where the data packet(s) are mDNS packets, the system may proceed to 304, otherwise the system 300A may continue to monitor and/or receive data packet(s) corresponding to traffic flow of the network. In some examples, the data packet(s) may be received by pattern component 118.

At 304, the system 300A may determine whether network discovery is enabled. For instance, where the system is implemented to detect mDNS packets, the system may determine whether mDNS network discovery feature is enabled.

Where the system 300A determines network discovery is not enabled (304-NO), the process proceeds to 306. At 306, the system 300A may end inspection of the data packet and resume monitoring traffic.

Where the system 300A determines network discovery is enabled (304-YES), the process proceeds to 308. At 308, the system may decode data packet(s). For instance, the system may utilize one or more algorithms and/or keys to decode the data packet(s). The system may decode the data packets using pattern component 118 based on the protocol used to encode the data packets.

At 310, the system 300A may determine whether a response type is TXT (16). For instance, the system may utilize pattern component 118 to parse the data packets and determine whether the responses are text responses (e.g., type 16). As noted above, the text responses (type 16), may contain device information such as the device's manufacturer and model, and occasionally a firmware version and/or an operating system version. Accordingly, the system 300A may determine to further inspect the data packet based on the data packet containing the text response.

Where the system 300A determines that the response type is not TXT (16) (310-NO), the process proceeds to 306. At 306, the system may end inspection of the data packet and resume monitoring traffic and/or performing inspection of other data packet(s). Where the system determines that the response type is TXT (16) (310-YES), the process proceeds to the operations shown in FIG. 3B.

FIG. 3B illustrates a flow diagram of an example system 300B inspecting data packets in order to enrich network maps and optimize network resource usage throughout a network, according to the techniques described herein. In some instances, the steps of system 300B may be performed by one or more devices (e.g., detection system 116, network device(s) 106, etc.) that include one or more processors and one or more non-transitory computer-readable media storing computer-executable instructions that, when executed by the one or more processors, cause the one or more processors to perform operations of system 300B. In some examples, the steps of system 300B may be performed in relation to enriching the network map. For instance, the steps of system 300B may be performed following the steps of system 300A of FIG. 3A.

At 312, the system 300B may parse decoded data for identifier(s). For instance, the pattern component 118 may be used to parse the decoded data. In some examples, the system may perform deep packet inspection on the data packet. The system may extract the decoded data as raw text. For instance, the system may initially extract data included in a “name” field. As noted above, the “name” field may be in the format “<device name>. <subprotocol type>” and/or may be compressed. For example, the name field may comprise data including “User's MacBook Pro._airplay._tcp.local” or “User's Energy Strip 5600._hap._tcp.local”.

At 314, the system 300B may determine whether there is a match in the database. For instance, the system may use the data from the “name” field to match the subprotocol type to a fingerprint in the database. For instance, the subprotocol type may be used to determine whether there is a match with a mDNS fingerprint stored in the database. Where there is a match, the system may extract connection data (e.g., such as NetBIOS data) from the decoded data, the database, device, etc. In some examples, the subprotocol type may comprise a hardware identifier. The mDNS fingerprint (e.g., in the database) may comprise a MAC address associated with the hardware identifier and may comprise NetBIOS information and/or other data (e.g., such as a name of the device, etc.).

In some examples, the system 300B may determine whether there are any duplicate hardware types included in the network map. For instance, the system may utilize a service (e.g., such as HostTracker, etc.) to determine whether a hardware type for a particular device is a duplicate. For example, the system 300B may determine whether the device indicated by the hardware type, name, and/or fingerprint is already included in the network map (e.g., running on the network), such that adding the device to the network map via an event would result in a duplicate device being shown. In some examples, the system may be configured to utilize filter(s) or other mechanisms to prevent duplicate addresses or false positives from being added to the network map. Accordingly, the system may prevent duplicate events from being created and/or included as part of the network map, thereby improving accuracy and visibility to the network.

Where the system 300B determines there is no match (314-NO), the process proceeds to 316. At 316, the system may generate and store a discovery event. As noted above, event is something that is created when a hardware type does not match any fingerprint in the database. The discovery event may be logged and stored for analysis at a later time. The discovery event may be utilized by the update component to update the database and/or improve the accuracy of algorithms utilized by the techniques described herein. The system 300B may then proceed to 306, where inspection of the data packet ends.

Where the system 300B determines there is a match in the database (314-YES), the process proceeds to 318. At 318, the system 300B may generate and store an event including the identifier(s) (e.g., device name, subprotocol type, hardware identifier, MAC address, etc.). In some examples, the system may parse the NetBIOS data and log the NetBIOS data as part of the event. For instance, where the system is configured for use with mDNS protocol, the system may determine that the fingerprint has not been added to the host tracker. In this example, the system may log the NetBIOS and the device information as part of an event (e.g., by creating a NEW_OS event and/or a CHANGE_NETBIOS_NAME event).

At 320, the system 300B may parse the decoded data for additional data associated with additional field(s). For instance, the system may parse the decoded data for data included in the “data” field(s) of the data packet. As noted above, the “data” field(s) may include data in a format of “<length><text>” that repeat, where each data (e.g., text section) is of the form “<key>=<value>”. The system may extract the additional data comprising device information from the “data” field. Keys do not come in a specified order, nor do they always appear. In some examples, the device information may include operating system version, model, etc.

At 322, the system 300B may determine whether there are additional match(es) in the database. For instance, the additional data included in the “data” field(s) may be individually read and matched with respective mDNS data fingerprints (e.g., patterns) of the specific subprotocol indicated by the “name” field. The patterns may be specific and/or general. As an example, a specific pattern may match both the “key” and “value” with fingerprint(s) in the database, where the database returns a separate, more informative value that is included as part of the event. A general pattern may just match the “key” to a fingerprint and may use the “value” as device information included in the event. For example, a specific pattern may be where the system searches the database for a match to “model=D53gAP”, where the “key” comprises “model=” and the “value” comprises “D53gAP”. In this example, the system may match a fingerprint in the database, which may return the data comprising “iPhone 12”, indicating the type of device. In another example, such as where the particular model is not stored in the database, the system may utilize a general pattern, where the “key” value (e.g., “model=”) is entered and/or searched and the “value” (e.g., “D53gAP”) is returned and stored as part of an event and/or used for future fingerprint updates and/or associations with the device.

Where the system 300B determines there are no additional match(es) (322-NO), the system may proceed to 306, where inspection of the data packet ends.

Where the system 300B determines there are additional match(es) (322-YES), the system may proceed to 324. At 324, the system 300B may update the event to include the additional data from the additional field(s), the device information, and/or any data associated with the fingerprints. For instance, the system may log the device information as part of the event and add the event to the network map. For instance, the system may send the event to a network map engine of the administrator device as map data. The map data may comprise instructions to cause the administrator device to update the network map displayed on a user interface to include the event. The system 300B may then proceed to 306, where inspection of the data packet ends.

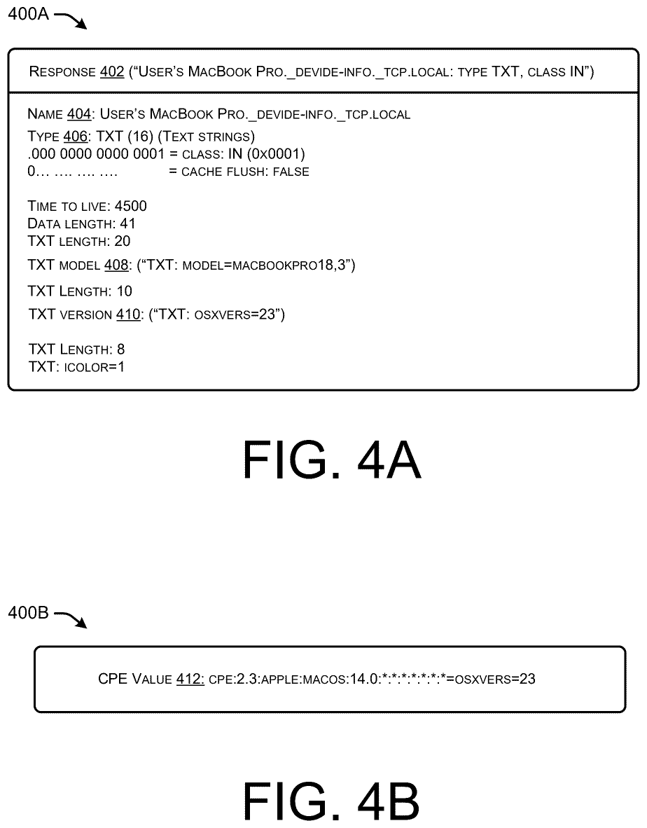

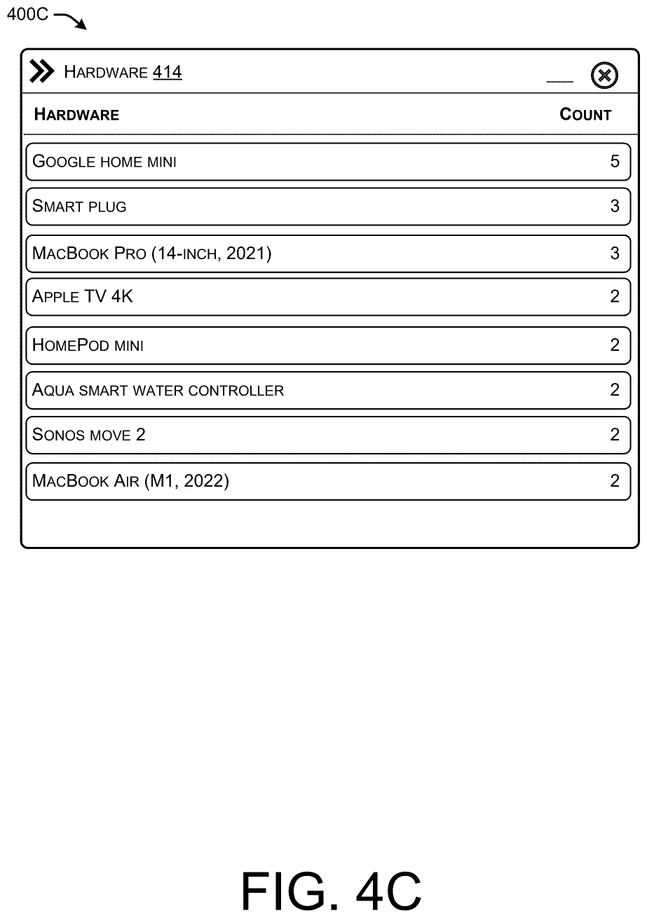

FIG. 4A illustrates an example of a response 400A that may be utilized by the detection system according to the techniques described herein. In some examples, the response 400A may correspond to response data 402 that is included as part of a data packet 112. For instance, the response data 402 may correspond to data included as part of mDNS packets.

As illustrated, the response data 402 may comprise a name 404, type 406, model 408 and/or version 410. In some examples, the name 404 corresponds to the name of the device and the type 406 corresponds to the type of response. For instance, type 406 comprises a text response (e.g., TXT (16)). As noted above, the system may determine whether the response is a text response in order to identify responses and/or data packets that comprise device information.

The model 408 corresponds to the type of device. The system may extract the model 408 and determine whether there is a match between the model and the database. Where there is a match, the system may return the name of the device and populate the name as part of the event. The version 410 may comprise an operating system version associated with a device 108. The system may extract the operating system version and determine whether there is a corresponding match in the database between the operating system version and a name in in the database. The system may further populate the version 410 as part of an event where there is a match and/or where there is not a match.

FIG. 4B illustrates an example of data 400B that may be included in an event, according to the techniques described herein. For instance, the data 400B may correspond to the response 400A data described in FIG. 4A herein. As illustrated, the data 400B may be converted into a CPE format. In some examples, the system may be configured to append a portion of the data 400B to the version 410.

For instance, in the illustrated example, the CPE value 412 comprises “cpe:2.3:o: apple: macos: 14.0:*:*:*:*:*:*:*=osxvers=23.” When generating the CPE value 412, the system may append the “cpe:2.3:o: apple:macos:14.0:*:*:*:*:*:*:*=” to the “osxvers=23” that is extracted from the response 400A.

Accordingly, where the system receives a lot of data packets, the system can match each message to a particular operating system and determine, based on the aggregate of the data packets from a particular device, which operating system is running on the network. Further, the system may do this for a plurality of devices. For instance, the system may determine the closest match for the plurality of data packets in order to determine the corresponding operating system running on the network.

FIG. 4C illustrates an example user interface 400C that may be displayed according to the techniques described herein. In some examples, the user interface 400C may be displayed via application 132 on the administrator device(s) 130. For instance, the user interface 400C may correspond to a firewall service that illustrates hardware running on a network to a network administrator. As shown, the user interface may include hardware 414 that shows various device(s) running on the network as well as a count corresponding to how many of each type of device is running on the network.

In some examples, the network administrator may utilize the user interface for additional functionalities (not illustrated). For instance, the network administrator may utilize the user interface to access the detection system in order to implement personalized recommended firewall intrusion prevention rules. In some examples, the network administrator may select one or more of the device(s) shown in user interface 400C in order to configure and/or manage asset allocation to each of the devices. For instance, the network administrator may change device settings, bandwidth settings, firewall rules, policies, etc. associated with each of the device(s) listed in the user interface 400C.

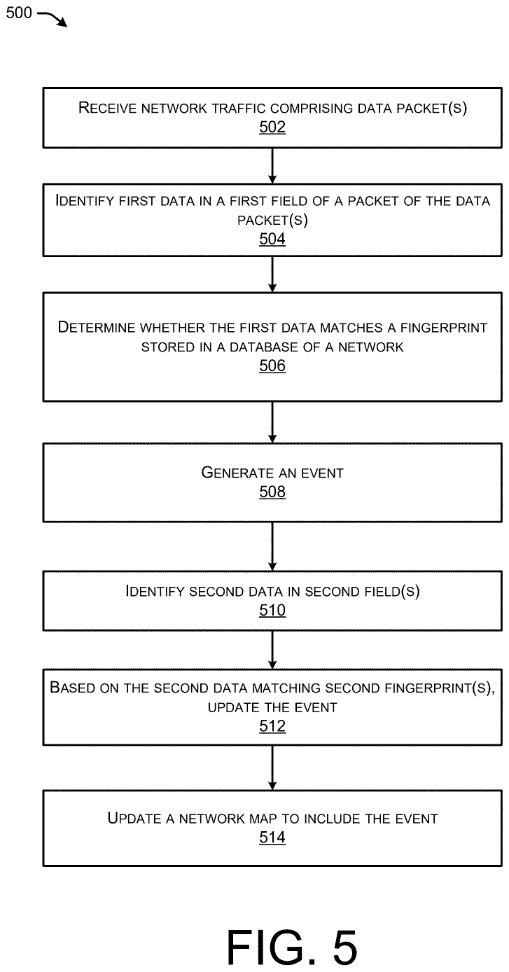

FIG. 5 illustrates a flow diagram of an example system 500 for enriching network maps according to the techniques described herein. In some instances, the steps of system 500 may be performed by one or more devices (e.g., detection system 116, network device(s) 106, etc.) that include one or more processors and one or more non-transitory computer-readable media storing computer-executable instructions that, when executed by the one or more processors, cause the one or more processors to perform operations of system 500.

At 502, the system may receive network traffic comprising data packet(s). In some examples, the system may be implemented by a detection system (e.g., such as detection system 116) of a network. For instance, the detection system 116 may comprise a mDNS service detector and/or be implemented as part of a firewall service. In some examples, the data packet(s) comprise multicast domain name system (mDNS) packets.

At 504, the system may identify first data included in a first field of a packet. In some examples, the packet is one of the data packet(s). In some examples, identifying the first data comprises: classifying the packet as being encoded according to a protocol; decoding the packet based on the protocol to generate decoded data; parsing the decoded data to identify the first data included in the first field; and extracting the first data as raw text. In some examples, such as where the first data comprises a device name and a hardware identifier and the fingerprint is associated with a specific pattern, the system may further: determine, based on the hardware identifier matching the fingerprint, an operating system associated with the device; and determine one or more additional matches between the second data and additional fingerprints, the one or more additional matches returning additional device data, wherein the second data comprises device information. In this example, the event is associated with the device and comprises the device information, the operating system, and the additional device data.

At 506, the system may determine whether the first data matches a fingerprint stored in a database of a network. For instance, the first data may comprise a subprotocol type and/or a hardware identifier. The system may determine whether the first data matches a stored pattern (e.g., fingerprint) in the database. In some examples, such as where a match is found, the system may proceed to 508. In some examples, the system may determine whether there is a match using one or more pattern recognition algorithms. In some examples, the database may comprise a virtual database.

In some examples, such as where the first data does not match any of the plurality of fingerprints stored in the database, the system may refrain from identifying the second data; generate a discovery event comprising the first data; and store the discovery event in the database. In this example, the system may determine, based on the discovery event, a hardware name associated with the first data; and update the database to include the hardware name and an association with the first data. In some examples, the system may also update one or more pattern matching algorithms based on the hardware name and the association.

At 508, the system may generate an event. For instance, the event may comprise the first data and the fingerprint. In some examples, the event may comprise NetBIOS data. In some examples, an event may be generated following an initial match between the first data and the fingerprint. In some examples, generating the event comprising the first data and the fingerprint is further based on determining the device associated with the first data and the fingerprint is not included in the network map.

At 510, the system may identify second data of second field(s) of the packet. For instance, the second data comprises one or more of a device model, a device manufacturer, an operating system version, and a device name associated with the device. The second data may be included as part of the “data” field of the data packet(s) 112.

At 512, the system may, based on determining the second data matches one or more second fingerprints in the database, update the event to include the second data and the one or more second fingerprints. For instance, the system may log the second data as part of the event.

At 514, the system may update a network map to include the event. In some examples, the network map comprises a network firewall map. In some examples, the system may update the network map using a map component and/or an update component of the service detector.

In some examples, the system may be implemented as part of a firewall service of the network. The system may determine, based on an operating system of the device, a firewall policy to apply to the device; and apply the firewall policy to the device.

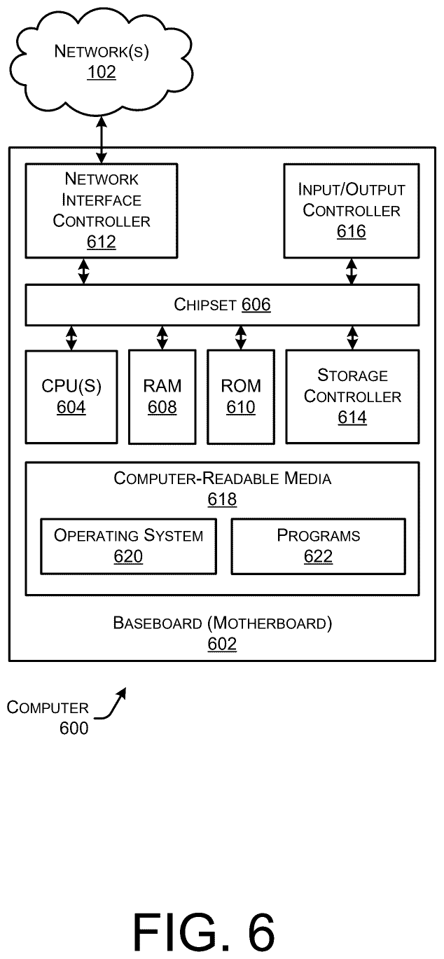

FIG. 6 shows an example computer architecture for a device capable of executing program components for implementing the functionality described above. The computer architecture shown in FIG. 6 illustrates any type of computer 600, such as a conventional server computer, workstation, desktop computer, laptop, tablet, network appliance, e-reader, smartphone, or other computing device, and can be utilized to execute any of the software components presented herein. The computer may, in some examples, correspond to a detection system 116 and/or any other device described herein, and may comprise personal devices (e.g., smartphones, tables, wearable devices, laptop devices, etc.), networked devices such as servers, switches, routers, hubs, bridges, gateways, modems, repeaters, access points, and/or any other type of computing device that may be running any type of software and/or virtualization technology.

The computer 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computer 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computer 600. The chipset 606 can further provide an interface to a computer-readable storage medium such as a read-only memory (“ROM”) 610 or non-volatile RAM (“NVRAM”) for storing basic routines that help to startup the computer 600 and to transfer information between the various components and devices. The ROM 610 or NVRAM can also store other software components necessary for the operation of the computer 600 in accordance with the configurations described herein.

The computer 600 can operate in a networked environment using logical connections to remote computing devices and computer systems through a network, such as network 102. The chipset 606 can include functionality for providing network connectivity through a NIC 612, such as a gigabit Ethernet adapter. The NIC 612 is capable of connecting the computer 600 to other computing devices over the network 102. It should be appreciated that multiple NICs 612 can be present in the computer 600, connecting the computer to other types of networks and remote computer systems.

The computer 600 can be connected to a storage device 618 that provides non-volatile storage for the computer. The storage device 618 can store an operating system 620, programs 622, and data, which have been described in greater detail herein. The storage device 618 can be connected to the computer 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computer 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 can further read information from the storage device 618 by detecting the physical states or characteristics of one or more particular locations within the physical storage units.

In addition to the mass storage device 618 described above, the computer 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 600. In some examples, the operations performed by the detection system 116 and/or any components included therein, may be supported by one or more devices similar to computer 600. Stated otherwise, some or all of the operations performed by the detection system 116 and/or any components included therein, may be performed by one or more computer devices.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computer 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computer 600.

In one embodiment, the storage device 618 or other computer-readable storage media is encoded with computer-executable instructions which, when loaded into the computer 600, transform the computer from a general-purpose computing system into a special-purpose computer capable of implementing the embodiments described herein. These computer-executable instructions transform the computer 600 by specifying how the CPUs 604 transition between states, as described above. According to one embodiment, the computer 600 has access to computer-readable storage media storing computer-executable instructions which, when executed by the computer 600, perform the various processes described above with regard to FIGS. 1-5. The computer 600 can also include computer-readable storage media having instructions stored thereupon for performing any of the other computer-implemented operations described herein.

The computer 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computer 600 might not include all of the components shown in FIG. 6, can include other components that are not explicitly shown in FIG. 6, or might utilize an architecture completely different than that shown in FIG. 6.

As described herein, the computer 600 may comprise one or more of a detection system 116 and/or any other device. The computer 600 may include one or more hardware processors (e.g., processors such as CPUs 604) configured to execute one or more stored instructions. The processor(s) may comprise one or more cores. Further, the computer 600 may include one or more network interfaces configured to provide communications between the computer 600 and other devices, such as the communications described herein as being performed by the detection system 116 and/or any other device. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 622 may comprise any type of programs or processes to perform the techniques described in this disclosure. For instance, the programs 622 may cause the computer 600 to perform techniques including receiving, from a device in the network, network traffic comprising one or more data packets; identifying first data included in a first field of a packet of the one or more data packets; and based on determining the first data matches a fingerprint of a plurality of fingerprints stored in a database of the network: generating an event comprising the first data and the fingerprint; identifying second data associated with one or more second fields of the packet; based on determining the second data matches one or more second fingerprints in the database, updating the event to include the second data and the one or more second fingerprints; and updating the network map to include the event.

In this way, the computer 600 may provide an improved detection system that can perform deep packet inspection of response data included in data packets. The computer 600 may provide the ability to detect device(s) not previously detectable, which utilizing new fingerprints in the database. By utilizing a database that provides fingerprints identifying device specific patterns, the computer 600 may more accurately identify device(s) running on a network. Accordingly, the computer 600 may provide improved asset and resource management of hardware running over a network. Moreover, the computer 600 may provide a network map that is more accurate. For instance, operating system identification of the network map may be improved with greater identification accuracy. With the combination of the fingerprints stored in the database and the rest of the derived fingerprints that come through the network maps algorithm, the computer 600 may provide more accurate results on the operating system of a platform. This improvement in operating system identification enables a personalized Firewall Intrusion prevention rule. For instance, the improved operating system detection algorithm also provides a more personalized version of the Firewall's Intrusion prevention policies by enabling the system to provide recommended and/or automated protection based on what operating systems are actually running on the network. For instance, based on the network running a particular operating system, the computer 600 may apply the firewall rules for that specific operating system. In contrast, existing techniques may implement firewall rules for a plurality of operating systems due to lack of visibility. Accordingly, the techniques may prevent excess firewall rules from being implemented, thereby freeing up network resources and preventing slowdowns in the network (e.g., due to lack of bandwidth, etc.).

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method for enriching a network map of a network, comprising:
receiving, from a device in the network, network traffic comprising one or more data packets;
identifying first data included in a first field of a packet of the one or more data packets; and
based on determining the first data matches a fingerprint of a plurality of fingerprints stored in a database of the network:
generating an event comprising the first data and the fingerprint;
identifying second data associated with one or more second fields of the packet;
based on determining the second data matches one or more second fingerprints in the database, updating the event to include the second data and the one or more second fingerprints; and
updating the network map to include the event.

2. The method of claim 1, wherein:
the packet comprises a multicast domain name system (mDNS) packet;
the method is implemented by a detection system corresponding to a mDNS service detector; and
the network map comprises a network firewall map.

3. The method of claim 1, wherein determining the first data matches the fingerprint comprises using one or more pattern matching algorithms.

4. The method of claim 1, wherein identifying the first data comprises:
classifying the packet as being encoded according to a protocol;
decoding the packet based on the protocol to generate decoded data;
parsing the decoded data to identify the first data included in the first field; and
extracting the first data as raw text.

5. The method of claim 4, wherein the first data comprises a device name and a hardware identifier and the fingerprint is associated with a specific pattern, further comprising:
determining, based on the hardware identifier matching the fingerprint, an operating system associated with the device; and
determining one or more additional matches between the second data and additional fingerprints, the one or more additional matches returning additional device data, wherein the second data comprises device information,
wherein the event is associated with the device and comprises the device information, the operating system, and the additional device data.

6. The method of claim 1, wherein the first data does not match any of the plurality of fingerprints stored in the database, further comprising:
refraining from identifying the second data;
generating a discovery event comprising the first data; and
storing the discovery event in the database.

7. The method of claim 6, further comprising:
determining, based on the discovery event, a hardware name associated with the first data; and
updating the database to include the hardware name and an association with the first data.

8. The method of claim 1, wherein the method is implemented as part of a firewall service of the network, further comprising:
determining, based on an operating system of the device, a firewall policy to apply to the device; and
applying the firewall policy to the device.

9. The method of claim 1, wherein the second data comprises one or more of a device model, a device manufacturer, an operating system version, and a device name associated with the device.

10. The method of claim 1, wherein generating the event comprising the first data and the fingerprint is further based on determining the device associated with the first data and the fingerprint is not included in the network map.

11. A system comprising:
one or more processors; and
one or more computer-readable media storing instructions that, when executed by the one or more processors, cause the one or more processors to perform operations comprising:
receiving, from a device in a network, network traffic comprising one or more data packets;
identifying first data included in a first field of a packet of the one or more data packets; and
based on determining the first data matches a fingerprint of a plurality of fingerprints stored in a database of the network:
generating an event comprising the first data and the fingerprint;
identifying second data associated with one or more second fields of the packet;
based on determining the second data matches one or more second fingerprints in the database, updating the event to include the second data and the one or more second fingerprints; and
updating a network map to include the event.

12. The system of claim 11, wherein:
the packet comprises a multicast domain name system (mDNS) packet;
the system comprises a detection system implemented by a mDNS service detector; and
the network map comprises a network firewall map.

13. The system of claim 11, wherein determining the first data matches the fingerprint comprises using one or more pattern matching algorithms.

14. The system of claim 11, wherein identifying the first data comprises:
classifying the packet as being encoded according to a protocol;
decoding the packet based on the protocol to generate decoded data;
parsing the decoded data to identify the first data included in the first field; and
extracting the first data as raw text.

15. The system of claim 14, wherein the first data comprises a device name and a hardware identifier and the fingerprint is associated with a specific pattern, the operations further comprising:
determining, based on the hardware identifier matching the fingerprint, an operating system associated with the device; and
determining one or more additional matches between the second data and additional fingerprints, the one or more additional matches returning additional device data, wherein the second data comprises device information,
wherein the event is associated with the device and comprises the device information, the operating system, and the additional device data.

16. The system of claim 11, wherein the first data does not match any of the plurality of fingerprints stored in the database, the operations further comprising:
refraining from identifying the second data;
generating a discovery event comprising the first data;
storing the discovery event in the database;
determining, based on the discovery event, a hardware name associated with the first data; and
updating the database to include the hardware name and an association with the first data.

17. The system of claim 11, wherein the system is implemented as part of a firewall service of the network, the operations further comprising:
determining, based on an operating system of the device, a firewall policy to apply to the device; and
applying the firewall policy to the device.

18. The system of claim 11, wherein the second data comprises one or more of a device model, a device manufacturer, an operating system version, and a device name associated with the device.

19. The system of claim 11, wherein generating the event comprising the first data and the fingerprint is further based on determining the device associated with the first data and the fingerprint is not included in the network map.

20. One or more non-transitory computer-readable media maintaining instructions that, when executed by one or more processors, program the one or more processors to perform operations comprising:
receiving, from a device in a network, network traffic comprising one or more data packets;
identifying first data included in a first field of a packet of the one or more data packets; and
based on determining the first data matches a fingerprint of a plurality of fingerprints stored in a database of the network:
generating an event comprising the first data and the fingerprint;
identifying second data associated with one or more second fields of the packet;
based on determining the second data matches one or more second fingerprints in the database, updating the event to include the second data and the one or more second fingerprints; and
updating a network map to include the event.
